(19) United States
(12) Patent Application Publication
(10) Pub. No.: US 2025/0231402 A1
(43) Pub. Date: Jul. 17, 2025

(54) DISPLAY APPARATUS

(71) Applicant: Yazaki Corporation, Tokyo (JP)

(72) Inventor: Harutoshi Nakajima, Makinohara-shi (JP)

(73) Assignee: Yazaki Corporation, Tokyo (JP)

(21) Appl. No.: 19/098,015

(22) Filed: Apr. 2, 2025

Related U.S. Application Data
(63) Continuation of application No. PCT/JP2024/005782, filed on Feb. 19, 2024.

(30) Foreign Application Priority Data
Mar. 22, 2023 (JP) 2023-045075

(51) Int. Cl. G02B 27/01; B60K 35/23

(52) U.S. Cl. CPC G02B 27/0101; B60K 35/23; B60K 2360/31; G02B 2027/011

(57) ABSTRACT

A display apparatus capable of displaying an image over a wide range of a front window without distortion is provided. The display apparatus includes a display unit disposed along the front window of a vehicle, wherein the display unit includes a plurality of display devices including a display region with a same curvature as the front window, and light emitted from the display unit is directly reflected directly on the front window to form a virtual image.

### TECHNICAL FIELD

This application is a continuation application of PCT International Application No. PCT/JP2024/005782, filed on Feb. 19, 2024, whose priority is claimed on Japanese Patent Application No. 2023-045075, filed on Mar. 22, 2023. All contents of both the PCT International Patent Application and the Japanese Patent Application are incorporated herein by reference.

The present invention relates to a display apparatus that displays a virtual image formed by reflection on the front window of a vehicle.

### BACKGROUND

It has been known that a head-up display mounted on a vehicle such as an automobile requires distortion correction processing when projecting a distortion-free display onto a curved front window of the vehicle.

For example, Patent Document 1 describes a head-up display device having a correction table for performing correction processing, including description about the amount of distortion correction for an image according to the projection position on the windshield, and performing the distortion correction for the image by referring to the amount of distortion correction described in the correction table, and correcting the size of objects by referring to the correction table in order to correct changes in the size of objects in the image that occur due to the distortion correction.

### RELATED ART

### Patent Document

Patent Document 1: JP2019161346A

### SUMMARY OF THE INVENTION

### Problem to be Solved by the Invention

To perform the above-described distortion correction processing, a display region larger than the actual display size is required. However, since the mounting space on the dashboard of an automobile is limited, it is difficult to display the image over a wide range of the front window.

Although displaying over a wide range is possible by combining multiple head-up displays, there are areas between the display devices where displaying is impossible in terms of structure, which imposes limitation on representation of a horizontally long linear display in terms of functionality and appearance.

In view of the above problems, it is an object of the present invention to provide a display apparatus capable of displaying an image over a wide range of the front window without distortion.

### Solution to Problem

The invention made to solve the above problems is a display apparatus including a display unit disposed along a front window in a vehicle cabin of a vehicle, wherein the display unit includes a plurality of display devices, a display region constituted by the plurality of display devices has a same curvature as the front window, and light emitted from the display unit is reflected directly on the front window to form a virtual image.

### Advantageous Effects of the Invention

According to the present invention, the display portion is disposed along the lower edge of the window, so that an image can be displayed over a wide range of the front window without distortion.

### BRIEF DESCRIPTION OF THE DRAWINGS

FIG. 1 is a configuration diagram of a display apparatus according to one embodiment of the present invention.

FIG. 2 is a top view of the dashboard illustrated in FIG. 1.

FIG. 3 is an enlarged view of a portion “A” illustrated in FIG. 2.

FIG. 4 is an example of a display by the display apparatus illustrated in FIG. 1.

### DETAILED DESCRIPTION OF THE EXEMPLARY EMBODIMENT

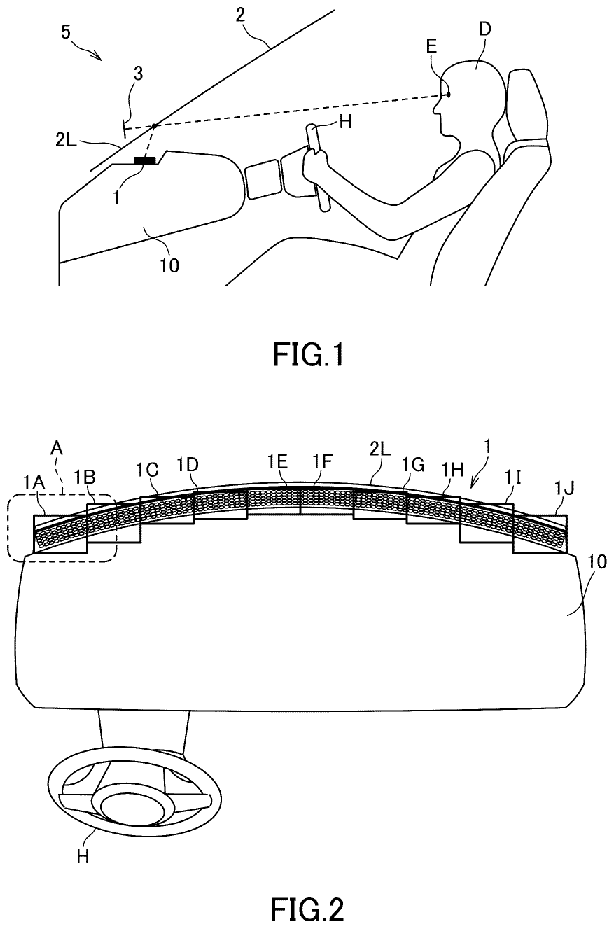

Hereinafter, an embodiment of the present invention is described with reference to the drawings. FIG. 1 is a configuration diagram of a display apparatus according to one embodiment of the present invention.

A display apparatus 5 illustrated in FIG. 1 is provided in a vehicle such as an automobile. As illustrated in FIG. 1, the display apparatus 5 includes a display unit 1. The display unit 1 is provided on a dashboard 10 in the vicinity of a lower edge 2L of a front window (also referred to as front glass or windshield) 2 of the vehicle. In other words, the display unit 1 is provided inside the vehicle cabin.

The dashboard 10 is a member that delimits the vehicle cabin space at the front of the vehicle, and is molded into a required shape.

In FIG. 1, reference symbol D denotes the driver of the vehicle, and reference symbol H denotes the steering wheel held by the driver D.

The display unit 1 is disposed on the dashboard 10 at the window side of the front window 2. In detail, as illustrated in FIG. 2, the display unit 1 is disposed along the shape of the lower edge 2L of the front window 2.

FIG. 2 is a top view of the dashboard 10. The display unit 1 is constituted by ten display devices, namely, display devices 1A to 1J.

The display devices 1A to 1J are configured with, for example, modular-type display devices, such as organic electroluminescence (EL) or liquid crystal display devices. The display devices 1A to 1J do not have frames (bezels) at least in the left-and-right direction, and are capable of displaying without any gaps, such as borders, between adjacent display devices.

As illustrated in FIG. 2, the display devices 1A to 1J are arranged at different positions in the depth direction of the dashboard 10 so that their respective display regions are aligned along the front window 2.

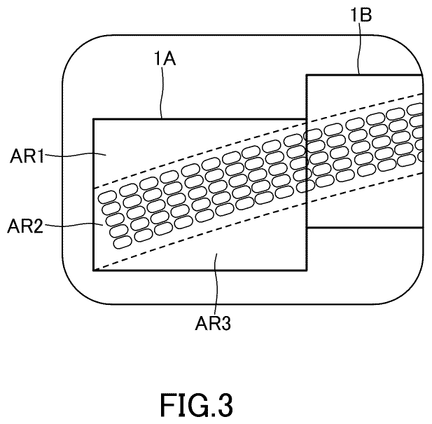

The display regions of the display devices 1A to 1J are explained with reference to FIG. 3. FIG. 3 illustrates an enlarged view of the portion “A” illustrated in FIG. 2. As illustrated in FIG. 3, the display device 1A includes areas AR1, AR2, and AR3 as displayable areas, of which the area AR2 is used as the actual display area (display region).

The area AR1 cannot be used as a display area because the area AR1 includes a portion that is not exposed on the surface of the dashboard 10. Although the area AR3 is exposed on the surface of the dashboard 10, the area AR3 is not used because there is a risk of an image being cut off when the image is displayed across the display devices 1A and 1B.

That is, in the present embodiment, a substantially band-shaped region capable of displaying across the display devices 1A to 1J is used as the display area. This band-shaped region is a region curved with the same curvature as the front window 2, as illustrated in FIG. 2. In this manner, the display unit 1 can display along the curvature of the front window 2. That is, the display unit 1 is constituted by multiple display devices 1A to 1J, and the display region constituted by the multiple display devices 1A to 1J has the same curvature as the front window 2.

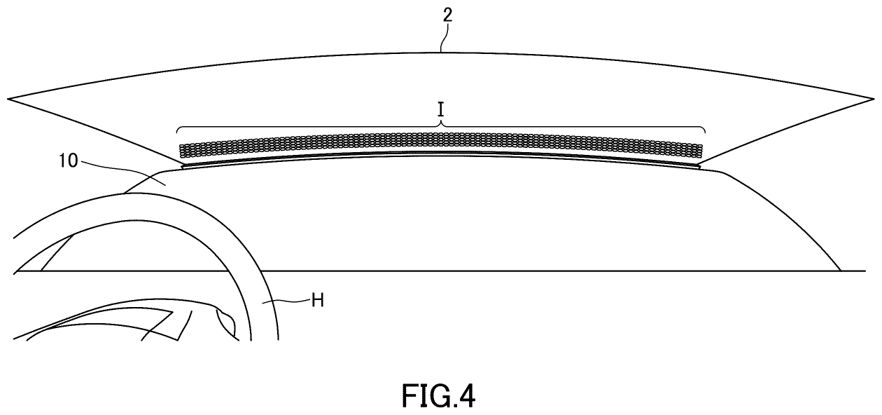

FIG. 4 is an example of a display by the display apparatus 5. As illustrated in FIG. 4, when an image is displayed on the display unit 1, an image I is displayed over a wide region from the left end to the right end of the front window 2. It is to be understood that this does not mean that the image is displayed in the entire region from the left end to the right end of the front window 2 at all times, but rather that it can be used as a display region as needed.

As illustrated in FIG. 1, in the display apparatus 5 according to the present embodiment, the light representing the image I displayed on the display unit 1 is directly reflected by the front window 2. When the light reflected by the front window 2 reaches the eyes E of the driver D who is holding the steering wheel H, the light is visually recognized by the driver D as a virtual image 3 on the lower part of the front window 2 on the outside of the vehicle cabin.

In this way, the display unit 1 is disposed along the curved shape of the front window 2, and accordingly, the image displayed on the display unit 1 is distorted with the same curvature as the front window 2, so that the image displayed on the front window 2 is not distorted, and there is no need to perform distortion correction processing or the like to display the image on the front window 2.

According to the present embodiment, the display unit 1 arranged along the front window 2 of the vehicle is provided, and the display unit 1 is constituted by the plurality of display devices 1A to 1J having display regions with the same curvature as the front window 2, and light emitted from the display unit 1 is reflected directly on the front window 2 to form the virtual image 3.

With the display apparatus 5 configured as described above, the display region of the display unit 1 is formed along the shape of the lower edge 2L of the front window 2, so that the display unit 1 displays an image distorted with the same curvature as the front window 2, resulting in an undistorted image displayed on the front window 2. Furthermore, because the display unit 1 is disposed along the front window 2, the display unit 1 can display over a wide range of the front window 2.

Furthermore, images can be displayed without borders, as compared to wide-area display that is achieved by combining multiple conventional head-up displays. Therefore, information conveyed to the driver D can be displayed at a flexible position and by a flexible display method, making it easier for the driver D to recognize the information.

Furthermore, since the display unit 1 is disposed from the left end to the right end of the lower edge 2L of the front window 2, an image can be displayed without distortion across the width of the front window 2.

Furthermore, since each of the display devices 1A to 1J is constructed as a module, the display devices 1A to 1J can be installed individually and can be easily attached to the vehicle.

In the above-described embodiment, the display devices 1A to 1J are in the rectangular shape, but if it is possible to adopt a display device whose shape can be changed, for example by cutting the unused areas AR1 and AR3, the footprint of the display unit 1 can be limited to only the region required for display.

Furthermore, the present invention is not limited to the above-described embodiment. In other words, a person skilled in the art can implement the present invention by modifying the present invention in various ways in accordance with conventional knowledge without departing from the gist of the present invention. It is to be understood that as long as a thus modified display apparatus has the configuration of the display apparatus of the present invention, the modified display apparatus is to be included in the scope of the present invention.

### List of Reference Signs

1 display unit
1A to 1J display device
2 front window
2L lower edge
3 virtual image
5 display apparatus

What is claimed is:

1. A display apparatus comprising:
a display unit disposed along a front window in a vehicle cabin of a vehicle,
wherein the display unit includes a plurality of display devices,
a display region constituted by the plurality of display devices has a same curvature as that of the front window, and
light emitted from the display unit is reflected directly on the front window to form a virtual image.

2. The display apparatus according to claim 1, wherein the display unit is disposed from a left end to a right end of the front window.

3. The display apparatus according to claim 1, wherein each of the plurality of display devices is configured as a module.

4. The display apparatus according to claim 2, wherein each of the plurality of display devices is configured as a module.
